(19) United States
(12) Patent Application Publication
(10) Pub. No.: US 2023/0253147 A1
(43) Pub. Date: Aug. 10, 2023

(54) RESONANT LC STRUCTURES

(71) Applicant: Resonant Link, Inc., South Burlington, VT (US)

(72) Inventors: Phyo Aung Kyaw, Winooski, VT (US); Aaron Stein, Essex, VT (US)

(73) Assignee: Resonant Link, Inc., South Burlington, VT (US)

(21) Appl. No.: 18/094,825

(22) Filed: Jan. 9, 2023

Related U.S. Application Data
(63) Continuation of application No. PCT/US21/41387, filed on Jul. 13, 2021.
(60) Provisional application No. 63/052,265, filed on Jul. 15, 2020.

(51) Int. Cl. H01F 38/14; H01F 27/06; H01F 27/28; H01F 27/32

(52) U.S. Cl. CPC H01F 38/14; H01F 27/06; H01F 27/2847; H01F 27/323; H01F 2038/146; H01F 2027/065; H01F 2027/2857

(57) ABSTRACT

A resonant coil structure may include a plurality of conductors, including: a first conductor having a first end and a second end; a second conductor having a third end and a fourth end; a third conductor having a fifth end and a sixth end; and a fourth conductor having a seventh end and an eight end; and at least one galvanic coupling conductor that galvanically couples the first end to the fifth end and galvanically couples the fourth end to the eighth end.

### CROSS REFERENCE TO RELATED APPLICATIONS

The present application claims priority under 35 U.S.C. § 120 to and is a continuation of International Application No. PCT/US2021/041387, filed Jul. 13, 2021, which claims priority under 35 U.S.C. 119(e) to U.S. Provisional Application 63/052,265, filed Jul. 15, 2020, each of which is hereby incorporated by reference in its entirety.

### BACKGROUND

### 1. Technical Field

The apparatus and techniques described herein relate to resonant inductive/capacitive (LC) structures.

### 2. Discussion of the Related Art

Electromagnetic components capable of handling high-frequency (HF) alternating current (AC) without incurring high losses are useful for building high-performance magnetic components such as those used in inductors and transformers for power conversion, and RF and microwave circuits. Electromagnetic components can generate external magnetic fields for use in wireless power transfer, induction heating and magnetic hyperthermia, among other applications.

### SUMMARY

A resonant coil structure may include a plurality of conductors, including: a first conductor having a first end and a second end; a second conductor having a third end and a fourth end; a third conductor having a fifth end and a sixth end; and a fourth conductor having a seventh end and an eight end; and at least one galvanic coupling conductor that galvanically couples the first end to the fifth end and galvanically couples the fourth end to the eighth end.

The resonant coil structure may further comprise a first insulating layer between the first conductor and the second conductor, a second insulating layer between the second conductor and the third conductor, and a third insulating layer between the third conductor and the fourth conductor.

The first conductor, the second conductor, the third conductor and/or the fourth conductor may comprise a plurality of turns.

The plurality of conductors may further comprise a fifth conductor galvanically coupled to the galvanic coupling conductor having a ninth end aligned with the first end and a tenth end aligned with the second end, and the resonant coil structure may further comprise a high-loss dielectric separating the first conductor from the fifth conductor.

The plurality of conductors may further comprise a sixth conductor galvanically coupled to the galvanic coupling conductor having an eleventh end aligned with the third end and a twelfth end aligned with the fourth end, and the resonant coil structure may further comprise a high-loss dielectric separating the second conductor from the sixth conductor.

The plurality of conductors may further comprise a seventh conductor galvanically coupled to the galvanic coupling conductor having a thirteenth end aligned with the fifth end and a fourteenth end aligned with the sixth end, and the resonant coil structure may further comprise a high-loss dielectric separating the third conductor from the seventh conductor.

The plurality of conductors may further comprise an eighth conductor galvanically coupled to the galvanic coupling conductor having a fifteenth end aligned with the seventh end and a sixteenth end aligned with the eighth end, and the resonant coil structure may further comprise a high-loss dielectric separating the fourth conductor from the eighth conductor.

The high-loss dielectric may comprise a printed circuit board substrate.

The at least one galvanic coupling conductor may galvanically couple each of the first end, the fourth end, the fifth end and the eighth end to each other.

The resonant coil structure may be inductively coupled to an excitation conductor to inductively excite the plurality of conductors.

The at least one galvanic coupling conductor may comprise a first galvanic coupling conductor that galvanically couples the first end and the fifth end and a second galvanic coupling conductor that galvanically couples the fourth end and the eighth end.

Any of the first to fourth conductors may be formed in a conductor layer.

Any of the first to fourth conductors may comprise a foil.

The conductor layer may have a C-shaped edge-wound shape.

The conductor layer may have a barrel-wound shape.

A plurality of resonant coil structures as in claim 1 may be connected to one another.

The plurality of resonant coil structures may be connected to one another in series.

The series connection of the plurality of resonant coil structures may have a ring-shape and each resonant coil structure may extend no more than partially around the ring.

The series connection of the plurality of resonant coil structures may extend more than 25% of the distance around the ring.

The series connection of the plurality of resonant coil structures may extends more than 50% of the distance around the ring.

The first, second, third and fourth conductors may be inductively coupled to one another.

Adjacent conductors of the first, second, third and fourth conductors may be capacitively coupled to one another.

The galvanic coupling conductor may comprise one or more vias, through-holes and/or slots plated or filled with one or more conductive materials.

The at least one galvanic coupling conductor may galvanically couple each of the ninth end, the twelfth end, the thirteenth end and the sixteenth end to each other.

A low frequency resonant structure may include: a plurality of stacked conductor layers disposed around a center point and inductively coupled to one another, successive conductors of the plurality of stacked conductor layers being capacitively coupled to one another though a respective dielectric layer, each of the plurality of stacked conductor layers having a first end and a second end; and a galvanic coupling conductor connected to first conductor layers of the plurality of stacked conductor layers at first ends of the first conductor layers and second conductor layers of the plurality of stacked conductor layers at second ends of the second conductor layers, wherein the plurality of stacked conductor layers form a closed current loop around the center point.

A resonant structure may include: a plurality of stacked conductor layers disposed around a center point and inductively coupled to one another, successive conductors of the plurality of stacked conductor layers being capacitively coupled to one another though a respective dielectric layer, each of the plurality of stacked conductor layers having a first end and a second end; a first conductor connecting first conductor layers of the plurality of stacked conductor layers at first ends of the first conductor layers; and a second conductor connecting second conductor layers of the plurality of stacked conductor layers at second ends of the second conductor layers.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A shows an example MCIC with four conductor layers separated by dielectric layers.

FIG. 1B shows an MCIC wrapped in an edge-wound manner around a cylindrical center mandrel or axis.

FIG. 1C shows an LFRS formed by shorting together the terminals of the MCIC of FIG. 1B.

FIG. 1D shows the LFRS of FIG. 1D and an inductive excitation coil.

FIG. 1E shows a side-view of the LFRS of FIGS. 1C and 1D.

FIG. 1F and FIG. 1G shows a top-views of a conductors of the structure of FIG. 1C, 1D and 1E.

FIG. 1H shows an example of a prototype of an LFRS.

FIG. 1I shows the magnitude of the impedance of the LFRS plotted versus frequency for the prototype of FIG. 1H.

FIG. 1J shows an example of a barrel-wound LFRS.

FIG. 2A shows another example of a LFRS with four conductive layers formed by a string of MCICs wrapped around a central axis, whose terminals are electrically connected to form a closed current loop.

FIG. 2B shows a top view of the top conductive layer of the LFRS of FIG. 2A, including conductors having a C-shape, separated from each other by respective gaps.

FIGS. 3A and 3B show top views of conductors illustrating that a conductor of an LFRS may have a plurality of concentric turns.

FIG. 3C shows a prototype of a multiple-turn edge-wound LFRS.

FIG. 4A shows an example of a C-shaped conductor layer.

FIG. 4B shows an example of a modified MCIC that can be constructed from alternating pairs of C-shaped conductor layers (e.g., foils) and C-shaped dielectric layers, where one or more of the C-shaped dielectric layers are formed of a high-loss material.

FIG. 4C shows an example of a modified LFRS that can be constructed from alternating pairs of C-shaped conductor layers (e.g., foils) and C-shaped dielectric layers, where one or more of the C-shaped dielectric layers are formed of a high-loss material.

FIG. 4D shows a side-view of the LFRS of FIG. 4C at the point where the galvanic connection is made.

FIG. 5 shows a side-view of the MSRS MCIC 100 of FIG. 1B at the location of the terminals.

### DETAILED DESCRIPTION

Electrical conductors operating at high frequency are impacted by the skin effect and the proximity effect. The former confines the HF current to the surface of the conductors, thereby significantly reducing the effective conductor cross-section; the latter causes magnetic field from one conductor to incur extra losses in adjacent conductors, resulting in non-uniform current density among conductors, increasing power loss.

Multilayer Self-Resonant Structures, or MSRSs, are resonant coils that may be made from alternating conductor (e.g., foil) layers and dielectric layers. These structures form an integrated inductive and capacitive component that achieves resonance with a single component. This integration can be used to force approximately equal current-density throughout the foil layers, which may significantly reduce the loss. Despite the promising performance of the MSRS, it may be difficult to integrate into a power electronic system because of the compensation architecture and constraints on the resonant frequency. Many embodiments of the MSRS are parallel resonators, which may require additional components to interface with voltage-fed power electronic topologies. Furthermore, MSRS embodiments may increase power electronic complexity and loss because of relatively high operating frequencies caused by 1) a single turn winding for creating magnetic flux, and 2) capacitance constraints due to integration of the winding and capacitor.

The inventors have developed a new electromagnetic component structure termed a “Low-Frequency Resonant Structure,” or LFRS, that can provide parallel resonance and achieve lower resonant frequencies than the MSRS given the same materials and size. The inventors have also developed improvements to the MSRS that enable the structure to be a series resonator and/or multiple turn resonator—enabling lower frequency operation and easier integration with power electronics.

### Low-frequency Resonant Structure (LFRS)

The LFRS may be formed of one, or a string of multiple multilayer conductors with integrated capacitance (MCIC) whose electrical terminals are connected to one another to provide a closed current loop through the integrated capacitance. The MCIC, or the string of multiple MCICs, may be placed, or wrapped, one or multiple times (single-turn or multiturn LFRS) around a central axis or a mandrel of any cross-section, in a barrel-wound or edge-wound manner. Each MCIC may have a plurality of electrical terminals. An LFRS may comprise a MCIC whose terminals are electrically shorted to each other, thereby closing the inductive current loop. Or an LFRS comprising a string of multiple MCICs may be constructed by electrically connecting the second terminal of one MCIC to the first terminal of the subsequent MCIC in the string, and the second terminal of the last MCIC in the string to the first terminal of the first MCIC in the string, thereby closing the inductive current loop. In an LFRS, the total length of the MCICs (along the direction of the current flow) may be greater than 25%, optionally greater than 50%, of the total length of the current loop—the remainder of the length of the current loop being the physical length of the electrical connections.

The multilayer conductor with integrated capacitance (MCIC) is an electromagnetic component with a plurality of electrical terminals and a plurality of conductor layers. When not shorted together, electrical terminals are conductors that can carry electrical current into or out of a component to interface it with electronic circuits or systems. In an MCIC, the plurality of conductor layers may be isolated from one another by separation dielectric layers, and each conductor layer may be electrically connected to only one of the electrical terminals, and the conductor layers are arranged such that every conductor layer is adjacent to—except for the separation dielectric layers—and have some overlapping area with at least one conductor layer connected to the other electrical terminal; the conductor layers connected to the different electrical terminals are defined as having opposite orientations. Multiple LFRSs, of the same or different designs, may be placed together on the same central axis or mandrel. One or more single-turn or multiturn electrical conductors or MCICs may be wrapped around the same central axis or mandrel as the LFRS, to provide galvanic connection to a larger electrical system or power electronics system (e.g., a power source or a load).

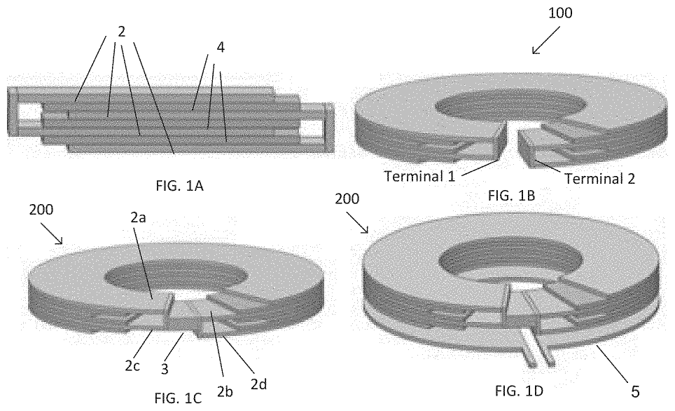

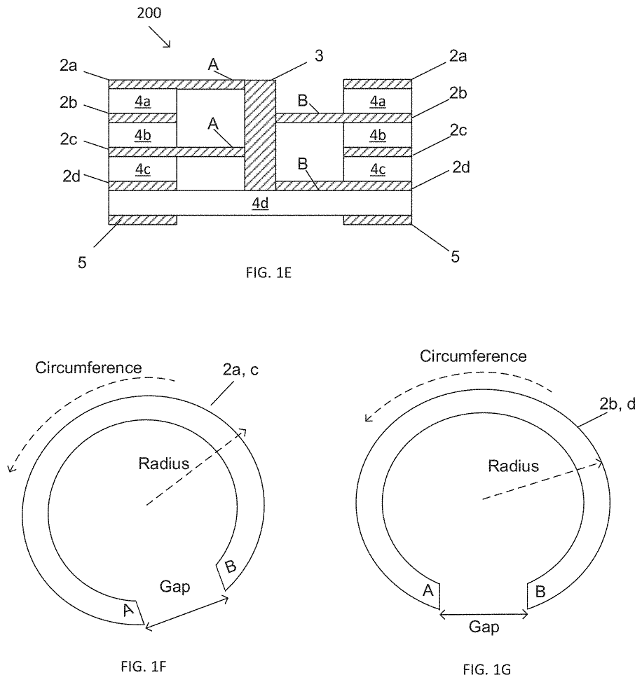

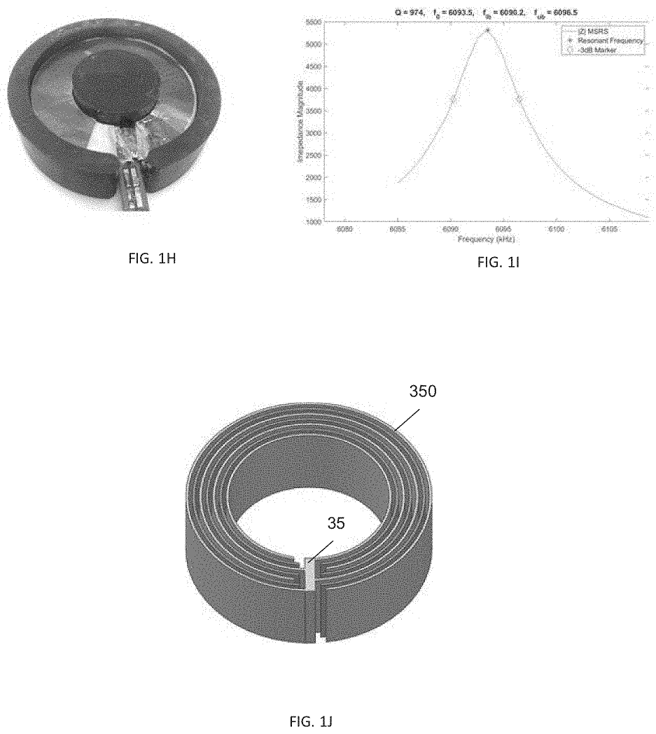

FIG. 1A shows an example MCIC with four conductor layers 2 separated by respective dielectric layers 4. When the MCIC of FIG. 1A is wrapped in an edge-wound manner around a cylindrical center mandrel or axis the result is the example MCIC shown in FIG. 1B. Shorting the two terminals of the example MCIC of FIG. 1B forms the example LFRS shown in FIG. 1C. Since the two terminals are shorted together, coupling into the LFRS of FIG. 1C may be performed using an inductive excitation coil 5, as shown in FIG. 1D.

Current is induced in an LFRS from an alternating magnetic field, which may be created by a current loop proximal to the LFRS. The overlapping areas of adjacent conductor layers, each connected to a different terminal, forms integrated capacitance, through which current induced by the magnetic field is transferred in the form of a displacement current. The magnetic field may be generated by current running through one or more electrical conductors 5 wrapped around the same central axis or mandrel as the LFRS (as shown in FIG. 1D). Although electrical conductor 5 is illustrated as a thin, planar, C-shaped, edge-wound conductor, the techniques and apparatus described are not limited in this respect, as conductor 5 may be any electrical conductor having any size, shape, or number of turns. Alternatively or additionally, the magnetic field may be produced by excitation of one or more physically separate electromagnetic components or resonant structures—for instance, in a wireless power transfer (WPT) system a LFRS in the wireless power receiver may be excited by the magnetic field produced by the wireless power transmitter. An LFRS may be used as part of the transmitter, receiver, or repeater coil system in a WPT system.

FIG. 1E shows a side-view of the LFRS 200 of FIGS. 1C and 1D. The four conductor 2a-2d are separated by respective dielectric layers 4a-4c, isolating the conductor layers along their length and forming integrated capacitances between adjacent layers of conductors 2a-2d. Specifically, conductor 2a is capacitively coupled to conductor 2b, conductor 2b is capacitively coupled to conductors 2a and 2c, conductor 2c is capacitively coupled to conductors 2b and 2d, and conductor 2d is capacitively coupled to galvanic coupling conductor 2c. Each of the conductors 2a-2d is galvanically shorted at one end by conductor 3. In this example, the A end of conductor 2a, the B end of conductor 2b, the A end of conductor 2c and the B end of conductor 2d are shorted together by galvanic coupling conductor 3. In other embodiments, the opposite ends may be shorted together: that is, the B end of conductor 2a, the A end of conductor 2b, the B end of conductor 2c and the A end of conductor 2d may be shorted together. The pattern of connecting opposite ends of adjacent conductors at galvanic coupling conductor 3 can be continued for an arbitrary number of conductor layers. Inductive coupling into the LFRS 200 may be performed by exciting conductor 5, which may be electrically isolated from the LFRS 200 by a dielectric layer 4d or other electrical insulator.

FIG. 1F shows a top-view of a conductor corresponding to conductors 2a and 2c, as both conductors 2a and 2c have the same shape in top-view. As shown, the ends A and B are separated by a gap. FIG. 1G shows a top-view of a conductor corresponding to conductors 2b and 2d, as both conductors 2b and 2d have the same shape in top-view. Again, the ends A and B are separated by a gap

The conductors 2, 3 and 5 (electrical conductors), may be, wholly or partially, made of any electrically conductive material or combination of materials, including but not limited to one or more metals such as silver, copper, aluminum, gold and titanium, and non-metallic materials such as graphite. The electrically conductive material may have an electrical conductivity of higher than 200 kS/m, optionally higher than 1 MS/m. The electrical conductors may have any physical shape including, but not limited to, solid material, foil, conductors laminated on a substrate, printed circuit board traces, electrode layers in multilayer ceramic capacitor (MLCC) processes, electrode layers in low-temperature co-fired ceramic (LTCC) processes, integrated circuit traces, or any combination of them.

Conductor layers, or electrical conductor layers or foils or foil layers, are electrical conductors in which the width of the conductor is much smaller (e.g., at least 10 times smaller) than the height of the conductor. Some examples may include, but are not limited to, foil layers forming a flat current loop (e.g. C-shaped, arc-shaped, rectangular-shaped, or any polygon-shaped conductors); foil layers wrapped around a cylinder or prism; barrel-wound and edge-wound conductors; and/or toroids or toroidal polyhedrons with circular, polygonal or rounded-polygon cross-section whose surfaces are wholly or partially covered with electrically conductive materials.

The conductor layers may be separated by any electrically non-conductive material (dielectric material) or combination of materials, including but not limited to one or more of air, FR4, PLA, ABS, polyimide, PTFE, polypropylene, a mix of PTFE and supporting materials for ease of handling (e.g. Rogers Substrates, Gore Materials, or Taconic TLY materials), plastic, glass, alumina, ceramic, dielectric or ceramic layers in multilayer ceramic capacitor (MLCC) processes, or dielectric or ceramic layers in low-temperature co-fired ceramic (LTCC) processes.

The galvanic coupling conductor between conductors 2 (e.g., galvanic coupling conductor 3), may be formed by any type of electrical connection. In some embodiments, such electrical connections include one or more vias, through-holes and/or slots plated or filled with one or more conductive materials. Electrical connections that include one or more vias, through-holes and/or slots plated or filled with conductive materials may be useful in MCICs formed by printed circuit board (PCB), multilayer ceramic capacitor (MLCC), or low-temperature co-fired ceramic (LTCC) processes and structures.

The LFRS may be placed near or inside a magnetic core (e.g., as shown in FIG. 1H). In an embodiment, the LFRS may be constructed such that the center mandrel around which the LFRS is placed is a magnetic core, or a portion of a magnetic core (e.g., a center post). The magnetic core may be, wholly or partially, made of one or more ferromagnetic materials, which have a relative permeability greater than 1, optionally greater than 10. The ferromagnetic materials may include, but are not limited to, one or more of iron, various steel alloys, cobalt, ferrites including manganese-zinc (MnZn) and/or nickel-zinc (NiZn) ferrites, nano-granular materials such as Co-Zr-O, and powdered core materials made of powders of ferromagnetic materials mixed with organic or inorganic binders. However, the techniques and devices described herein are not limited as to the particular material of the magnetic core. The shape of the magnetic core may be: a pot core, a sheet (I core), a sheet with a center post, a sheet with an outer rim, RM core, P core, PH core, PM core, PQ core, E core, EP core, EQ core. However, the techniques and devices described herein are not limited to particular magnetic core shapes.

Experimental results validate the high-Q and low-frequency capabilities of this embodiment of the LFRS. A prototype (FIG. 1H) was constructed from 13 layers of copper foil (conductor layer) with a foil thickness of 12.5 microns. The foil layers were separated from one another by 50 micron thick PTFE (dielectric layer). The LFRS was placed in a magnetic pot core having a diameter of 6.6 cm. A single C-section drive layer was used to excite the LFRS. The resulting resonant coil had a Q of 974 at frequency of 6.09 MHz (FIG. 1I). FIG. 1I shows the magnitude of the impedance of the LFRS plotted versus frequency. The Q may be four times higher than coils constructed using conventional approaches, and the resonant frequency may be more than three times lower than an MSRS constructed using similar number of layers of similar materials.

FIG. 1J shows an example of a barrel-wound LFRS 350, which is an example of a barrel-wound MCIC, according to some embodiments. The barrel-wound LFRS 350 is similar to LFRS 200, but with the conductors extending in a barrel-wound manner rather than an edge-wound manner. In the barrel-would LFRS 350 the conductors have their thinnest dimension extending in the radial direction, rather than in the vertical dimension, as in LFRS 200. Galvanic coupling conductor 35 extends in the radial direction to connect the conductors 2 at alternating ends, as described above for LFRS 200. The barrel-wound LFRS 350 has a circular cross-section (top view), however a barrel-wound MCIC may have any cross-section, not limited to circular. Any of the structures described herein may be formed in a barrel-wound manner, not limited to the LFRS.

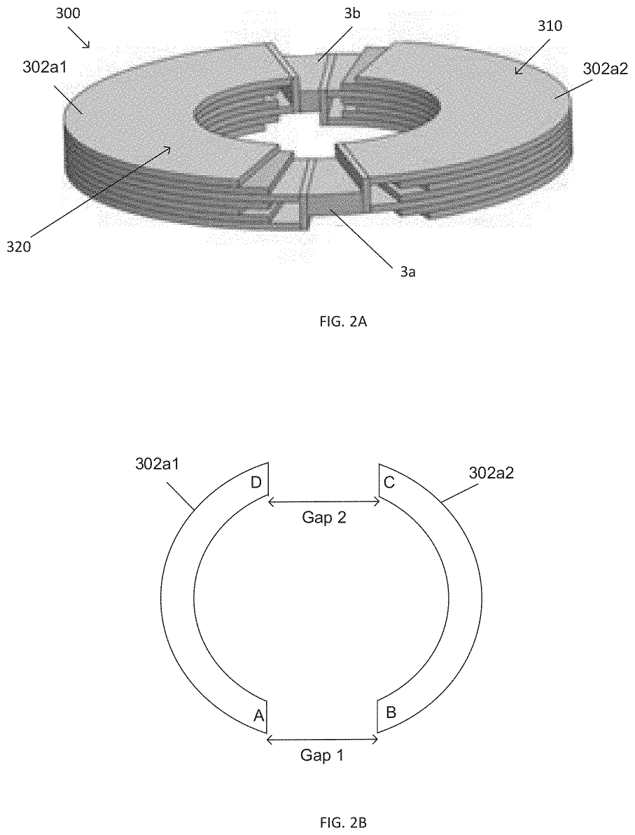

FIG. 2A shows another example of a LFRS 300 with conductive layers formed by a string of MCICs wrapped around a central axis, whose terminals are electrically connected to form a closed current loop. In this example, the LFRS 300 has four conductive layers and a string of two MCICs (310, 320). LFRS 300 is similar to LFRS 200, with the exception that instead of one galvanic connection point for LFRS 200 (at galvanic coupling conductor 3), LFRS 300 includes two such connection points (galvanic coupling conductors 3a and 3b). Each MCIC 310, 320 extends slightly less than half the circumference of the MCIC, in this example. However, the techniques and structures described herein are not limited in this respect. In some embodiments, such as those with vias connecting conductors 2, each MCIC may extend half the circumference of the MCIC. Further, although each MCIC may have the same extent along the circumference, their extent along the circumference may not be equal. For example, one MCIC may extend for one quarter of the circumference and another MCIC may extend for three quarters of the circumference.

FIG. 2B shows a top view of the top conductive layer including conductors 302a and 302b, each having a C-shape, separated from each other by respective gaps Gap 1 and Gap 2. The MCICs 310 and 320 may have their conductors galvanically connected to each other at Gap 1 and Gap 2 in the same way as shown in FIG. 1E for conductors 2, with ends A and B replaced by ends C and D, respectively for Gap 2. Further, although LFRS 300 includes two MCICs, it should be appreciated that a string of MCICs may have any number of two or more MCICs. The string of MCICs may have a corresponding number of connection points which may be at any location around the circumference of the LFRS.

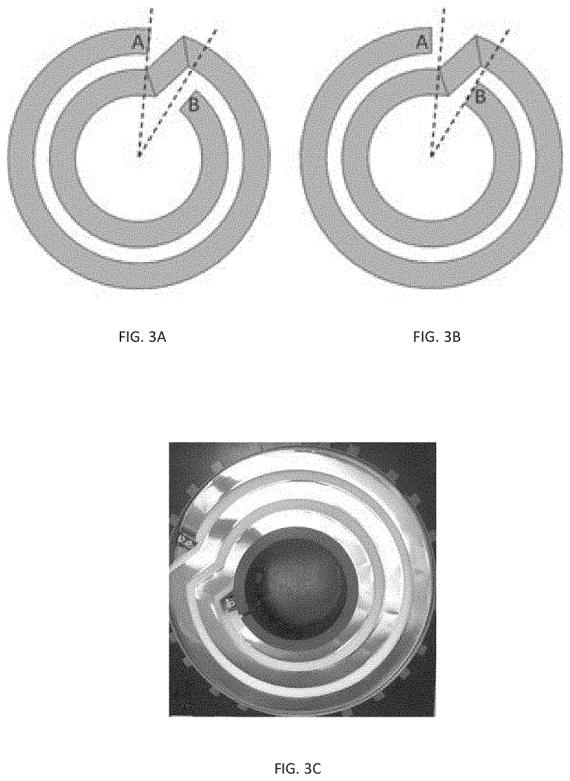

In some embodiments, an LFRS may be formed with a conductor that extends around a central axis or mandrel for a plurality of turns. FIGS. 3A and 3B show top views of conductors illustrating that a conductor of an LFRS may have a plurality of concentric turns. However, the structures described herein are not limited to having concentric turns. In the example of FIGS. 3A and 3B, the conductor is edge-wound. An LFRS may be formed by replacing the conductors 2a, 2b, etc., of LFRS 200 with one or more conductors that extend around a central axis or mandrel for a plurality of turns, as shown in FIGS. 3A and 3B, for example.

In some embodiments, the LFRS can be constructed from alternating layers of spiral shaped conductor layers separated by dielectric layers optionally placed in or near a magnetic core. For this embodiment, consider a spiral of foil where the beginning of the spiral along the outer diameter is Point A and the end of the spiral along the inner diameter is Point B (see FIG. 3A and 3B for an embodiment with a 2-turn spiral). A plurality of such foils are stacked together, alternating in shape between FIG. 3A and FIG. 3B. The Points A of every other conductor layer corresponding to FIG. 3A are connected together to form a terminal of the MCIC (Terminal 1) and the Points B of the remaining alternating conductor layers corresponding to FIG. 3B are connected together to form the other terminal of the MCIC (Terminal 2), with the dashed lines representing the angular locations of the terminals where two or more spirals are shorted together. The Points A of the conductor layers connected to Terminal 2 are offset by an angle along the spiral, from those connected to Terminal 1; and the Points B of the conductor layers connected to Terminal 1 are offset by an angle, along the spiral, from those connected to Terminal 2. This angular offset provides the additional space to form the two electrical terminals while providing galvanic isolation for Points A of the conductor layers connected to Terminal 2 and Points B of the conductor layers connected to Terminal 1. The Terminal 1 and Terminal 2 of the MCIC may be galvanically connected to form the LFRS; this galvanic connection may be constructed using any electrical conductor. It should be noted that this pattern can be continued for an arbitrary number of conductor layers.

Experimental results validate the low-frequency capabilities of the multiple-turn edge-wound LFRS. A prototype (FIG. 3C) of this embodiment was constructed from 75 micron thick aluminum foil layers separated by 50 micron thick PTFE. FIG. 3C shows a top view. The terminals of MCIC are shorted underneath the blue plastic cup. The prototype has approximately 77 foil layers, where each layer is a 3-turn spiral. The resulting LFRS had a resonant frequency of 85 kHz, which may be 3× lower than the lowest-frequency MSRS.

Some embodiments of the LFRS structure allow high-loss substrates to be incorporated into the LFRS without adding significant loss. This structure is herein termed the Modified LFRS. In an LFRS made of an MCIC in which every conductor layer, on both sides of the layer, is adjacent to—except for the separation dielectric layers—conductor layers with opposite orientations, dielectric layers made of a high-loss material may result in poor performance (low-Q). An LFRS which may partially be constructed using high-loss dielectric or substrate material can enable construction of the LFRS using standard printed circuit board (PCB) processes. PCBs are typically thin foil laminated on substrates (e.g. FR4, polyimide, or Rogers' material), which may have loss tangents too high to make an effective LFRS.

The inventors recognize that if the two conductors adjacent to a high-loss dielectric or substrate layer are duplicated—same orientation and same galvanic connections, then the impact of the high-loss substrate will be significantly reduced. The high-loss substrate is any dielectric or substrate material that has a loss-tangent greater than that of any other dielectric layer, optionally greater than 1.5× of that of the dielectric layer.

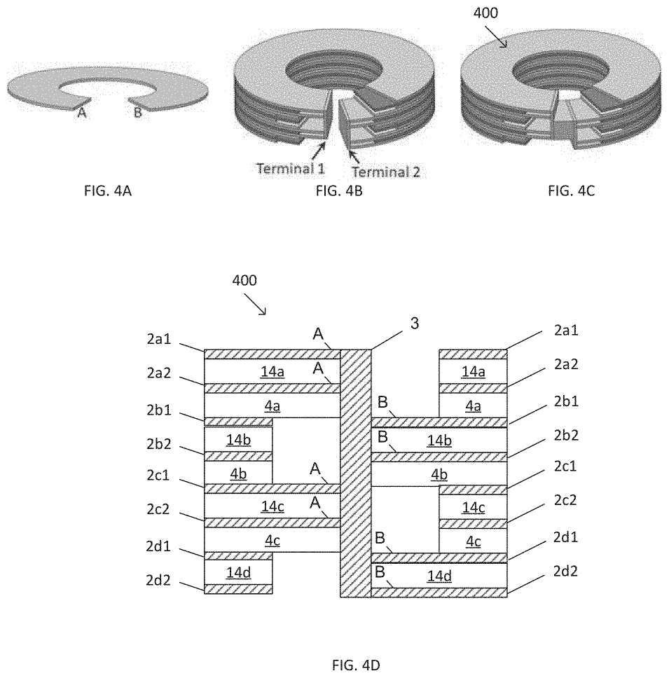

FIG. 4 shows an embodiment of the modified LFRS that can be constructed from alternating pairs of C-shaped conductor layers (e.g., foils) and C-shaped dielectric layers, optionally placed in a magnetic core. In FIGS. 4B and 4C, low-loss dielectric layers are shown in light grey, and high-loss substrate layers are shown in dark grey. A pair of C-shaped foils is two adjacent (except for the separation dielectric or substrate layer) C-shaped foil layers with the same orientation, in which the same end point of the C-shape (A or B) is connected to the same terminal (Terminals 1 or 2). The pair of C-shaped foils may be constructed using standard printed circuit board processes and separated by any dielectric material including FR4 and polyimide. FIG. 4C shows an example Modified LFRS made of a MCIC wrapped in an edge-wound manner once around a cylindrical center point or mandrel, in which each conductor layer is adjacent to one conductor layer with the same orientation on one side and one with the opposite orientation on the other side. FIG. 4A shows the C-shaped foil layers from which the example Modified LFRS is made, showing the Points A and B. FIG. 4B shows the MCIC comprising the C-shaped conductors and from which the Modified LFRS is made. It comprises eight C-shaped conductor layers, or four pairs of C-shaped conductor layers. Each pair is electrically connected to the same electrical terminal (Terminals 1 or 2) in an alternating manner such that counting from the top, the Points A of the first pair (layers 1 and 2) and the third pair (layers 5 and 6) of C-shaped conductor layers are connected to form Terminal 1 and the Points B of the second pair (layers 3 and 4) and the fourth pair (layers 7 and 8) of C-shaped conductor layers are connected to form Terminal 2. Terminals 1 and 2 of the MCIC can then be electrically shorted to form the modified LFRS 400 shown in FIG. 4C. It should be noted that this pattern can be continued for an arbitrary number of pairs of conductor layers. It should also be noted that each conductor layer has only one galvanic connection (e.g. Point A of layers 1 and 2, Points B of layers 3 and 4, etc.). FIG. 4D shows a side-view of the LFRS 400 of FIG. 4C at the point where the galvanic connection is made. Conductor layers 2a1 and 2a2 are duplicated conductors separated by a layer 14a that may be formed of a high loss material. Conductor layers 2a1 and 2a2 are galvanically connected to galvanic coupling conductor 3 at their ends A. Conductors 2b1 and 2b2 are duplicated conductors separated by a layer 14b that may be formed of a high loss material. Conductor layers 2b1 and 2b2 are galvanically connected to galvanic coupling conductor 3 at their ends B. Conductor layers 2c1 and 2c2 are duplicated conductors separated by a layer 14c that may be formed of a high loss material. Conductor layers 2c1 and 2c2 are galvanically connected to galvanic coupling conductor 3 at their ends A. Conductors 2d1 and 2d2 are duplicated conductors separated by a layer 14d that may be formed of a high loss material. Conductor layers 2d1 and 2d2 are galvanically connected to conductor 3 at their ends B. The remaining dielectric layers 4a-4c may be formed of a low-loss material.

Some embodiments relate to improvements to the MSRS that enable the structure to be series-resonant and/or have multiple turns, enabling lower-frequency operation and easier integration with a larger electrical system or power electronics system, enabling easier integration with power electronics. One embodiment is shown in FIG. 1B, which differs from the LFRS of FIG. 1C by omitting the galvanic coupling conductor 3 that forms a complete current loop in FIG. 1C. As mentioned above, the inventors recognize that multilayer conductors with integrated capacitance (MCIC), or a string of MCICs, may be placed, or wrapped, one or multiple times (single-turn or multiturn MSRS) around a central axis or a mandrel of any cross-section, in a barrel-wound or edge-wound manner. The resulting MSRS structure has at least two terminals, where galvanic connections may be used to interface the component with a larger electrical system or power electronic system. Each conductor layer in an MSRS is connected to no more than one terminal of the MCIC, and is separated from adjacent conductor layers by dielectric layers. The resulting structure can optionally be placed near or inside a magnetic core. The resulting structure may be used as either a standalone electromagnetic component (e.g., wireless power transfer coil or passive network power conversion), or as a sub-component in an electromagnetic structure (e.g. exciter winding for LFRS or another MSRS).

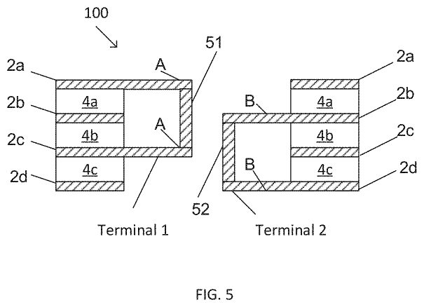

FIG. 5 shows a side-view of the MSRS 100 of FIG. 1B at the location of the terminals. The structure is the same as that of the LFRS 200, as shown in FIG. 1E, with the omission of galvanic coupling conductor 3. Instead, MSRS 100 includes a conductor 51 connecting the A ends of conductors 2a and 2c at Terminal 1, and a conductor 52 connecting the B ends of conductors 2b and 2d at Terminal 2. In some embodiments, an edge-wound single-turn series MSRS, such as shown in FIG. 1B and FIG. 5, may have up to a 2× reduction in resonant frequency compared to prior MSRSs.

In some embodiments, an MSRS may be formed similar to that shown in FIG. 1B and FIG. 5, but with one or more coils of a plurality of turns, as illustrated in FIG. 3A and 3B and discussed above. Such an embodiment may have significantly more than a 2× reduction in resonant frequency compared to prior MSRSs.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A resonant coil structure, comprising:
a plurality of conductors, including;
a first conductor having a first end and a second end;
a second conductor having a third end and a fourth end;
a third conductor having a fifth end and a sixth end;
a fourth conductor having a seventh end and an eighth end; and
at least one galvanic coupling conductor that galvanically couples the first end to the fifth end and galvanically couples the fourth end to the eighth end.

2. The resonant coil structure of claim 1, further comprising a first insulating layer between the first conductor and the second conductor, a second insulating layer between the second conductor and the third conductor, and a third insulating layer between the third conductor and the fourth conductor.

3. The resonant coil structure of claim 1, wherein the first conductor, the second conductor, the third conductor and/or the fourth conductor comprises a plurality of turns.

4. The resonant coil structure of claim 1, wherein the plurality of conductors further comprises a fifth conductor galvanically coupled to the at least one galvanic coupling conductor having a ninth end aligned with the first end and a tenth end aligned with the second end, and the resonant coil structure further comprises a high-loss dielectric separating the first conductor from the fifth conductor,
wherein the plurality of conductors further comprises a sixth conductor at least one galvanically coupled to the galvanic coupling conductor having an eleventh end aligned with the third end and a twelfth end aligned with the fourth end, and the resonant coil structure further comprises a high-loss dielectric separating the second conductor from the sixth conductor,
wherein the plurality of conductors further comprises a seventh conductor galvanically coupled to the at least one galvanic coupling conductor having a thirteenth end aligned with the fifth end and a fourteenth end aligned with the sixth end, and the resonant coil structure further comprises a high-loss dielectric separating the third conductor from the seventh conductor, and/or
wherein the plurality of conductors further comprises an eighth conductor galvanically coupled to the at least one galvanic coupling conductor having a fifteenth end aligned with the seventh end and a sixteenth end aligned with the eighth end, and the resonant coil structure further comprises a high-loss dielectric separating the fourth conductor from the eighth conductor.

5. The resonant coil structure of claim 4, wherein the high-loss dielectric comprises a printed circuit board substrate.

6. The resonant coil structure of claim 1, wherein the at least one galvanic coupling conductor galvanically couples each of the first end, the fourth end, the fifth end and the eighth end to each other.

7. The resonant coil structure of claim 1, wherein the resonant coil structure is inductively coupled to an excitation conductor to inductively excite the plurality of conductors.

8. The resonant coil structure of claim 1, wherein the at least one galvanic coupling conductor comprises a first galvanic coupling conductor that galvanically couples the first end and the fifth end and a second galvanic coupling conductor that galvanically couples the fourth end and the eighth end.

9. The resonant coil structure of claim 1, wherein any of the first to fourth conductors is formed in a conductor layer.

10. The resonant coil structure of claim 9, wherein any of the first to fourth conductors comprises a foil.

11. The resonant coil structure of claim 9, wherein the conductor layer has a C-shaped edge-wound shape.

12. The resonant coil structure of claim 9, wherein the conductor layer has a barrel-wound shape.

13. A plurality of resonant coil structures comprising the resonant coil structure of claim 1 and a second resonant coil structure, the second resonant coil structure comprising:
a second plurality of conductors, including;
a fifth conductor having a ninth end and a tenth end;
a sixth conductor having an eleventh end and a twelfth end;
a seventh conductor having a thirteenth end and a fourteenth end;
an eighth conductor having a fifteenth end and a sixteenth end; and
at least one second galvanic coupling conductor that galvanically couples the ninth end to the thirteenth end and galvanically couples the twelfth end to the sixteenth end,
wherein the resonant coil structure and the second resonant coil structure are connected to one another.

14. The plurality of resonant coil structures of claim 13 connected to one another in series.

15. The plurality of resonant coil structures of claim 14, wherein the series connection of the plurality of resonant coil structures has a ring-shape and each resonant coil structure extends no more than partially around the ring.

16. The plurality of resonant coil structures of claim 15, wherein the series connection of the plurality of resonant coil structures extends more than 25% of the distance around the ring.

17. The plurality of resonant coil structures of claim 15, wherein the series connection of the plurality of resonant coil structures extends more than 50% of the distance around the ring.

18. The resonant coil structure of claim 1, wherein the first, second, third and fourth conductors are inductively coupled to one another.

19. The resonant coil structure of claim 1, wherein adjacent conductors of the first, second, third and fourth conductors are capacitively coupled to one another.

20. The resonant coil structure of claim 1, wherein the at least one galvanic coupling conductor comprises one or more vias, through-holes and/or slots plated or filled with one or more conductive materials.

21. The resonant coil structure of claim 4, wherein the at least one galvanic coupling conductor galvanically couples each of the ninth end, the twelfth end, the thirteenth end and the sixteenth end to each other.

22. A low frequency resonant structure, comprising:
a plurality of stacked conductor layers disposed around a center point and inductively coupled to one another, successive conductors of the plurality of stacked conductor layers being capacitively coupled to one another though a respective dielectric layer, each of the plurality of stacked conductor layers having a first end and a second end; and
a galvanic coupling conductor connected to first conductor layers of the plurality of stacked conductor layers at first ends of the first conductor layers and second conductor layers of the plurality of stacked conductor layers at second ends of the second conductor layers,
wherein the plurality of stacked conductor layers form a closed current loop around the center point.

23. A resonant structure, comprising:
a plurality of stacked conductor layers disposed around a center point and inductively coupled to one another, successive conductors of the plurality of stacked conductor layers being capacitively coupled to one another though a respective dielectric layer, each of the plurality of stacked conductor layers having a first end and a second end;
a first conductor connecting first conductor layers of the plurality of stacked conductor layers at first ends of the first conductor layers; and
a second conductor connecting second conductor layers of the plurality of stacked conductor layers at second ends of the second conductor layers.
